(19) United States
(12) Patent Application Publication
(10) Pub. No.: US 2022/0237397 A1
(43) Pub. Date: Jul. 28, 2022

(54) IDENTIFYING HANDWRITTEN SIGNATURES IN DIGITAL IMAGES USING OCR RESIDUES

(71) Applicant: SAP SE, Walldorf (DE)

(72) Inventor: Jianglei Han, Singapore (SG)

(73) Assignee: SAP SE, Walldorf (DE)

(21) Appl. No.: 17/160,041

(22) Filed: Jan. 27, 2021

(51) Int. Cl. G06K 9/00; G06K 9/62; G06N 3/08

(52) U.S. Cl. CPC G06K 9/00161; G06K 9/6226; G06K 2209/01; G06N 3/08; G06K 9/00456

(57) ABSTRACT

Technologies are described for automatically identifying handwritten signatures within digital images using OCR residues. For example, a digital image of a scanned document is received. The scanned document comprises typewritten content and handwritten content. Optical character recognition (OCR) is performed on the digital image to identify typewritten text within the digital image. Pixel areas containing the identified typewritten text are removed from the digital image. Density-based clustering is performed on the digital image to cluster remaining pixel data and generate candidate segments. The candidate segments are then processed using a trained image classifier to determine if they contain handwritten signatures.

### BACKGROUND

Document processing technology involves the conversion of paper documents containing typed and/or handwritten content, into electronic documents. Conversion of paper documents can be performed by scanning or other image capture technology (e.g., using digital cameras). Digital images of scanned documents can be further processed using techniques such as optical character recognition (OCR).

Documents, such as business documents, normally contain printed text (e.g., generated by a computer printer). However, signatures on such documents are often handwritten. While technologies such as OCR can be applied to recognize typewritten content, such technologies may have difficulty recognizing handwritten content. For example, a document processing solution may not be able to recognize handwritten content, such as handwritten signatures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for identifying handwritten signatures within digital images using Optical character recognition (OCR) residues. For example, a digital image of a scanned document is received. The scanned document comprises typewritten content and handwritten content. OCR is performed on the digital image to identify typewritten text within the digital image. Pixel areas containing the identified typewritten text are removed from the digital image. Density-based clustering is performed on the digital image to cluster remaining pixel data (the pixel data in the digital image after the identified typewritten text has been removed) within the digital image. The density-based clustering produces candidate segments (pixel areas that could contain handwritten content, such as handwritten signatures). The candidate segments are then processed using a trained image classifier. The trained image classifier determines whether a given candidate segment contains a handwritten signature. Results of the processing are then output. For example, an indication of which candidate segments contain digital signatures can be output.

### BRIEF DESCRIPTION OF THE DRAWINGS

FIG. 1 is a diagram depicting an example service flow for determining whether a scanned document is signed with a handwritten signature.

FIG. 2 depicts an example digital image of a scanned document, including typewritten text that has been identified using OCR.

FIG. 3 depicts an example digital image after the pixel areas containing identified typewritten text have been removed.

FIG. 4 depicts an example digital image after density-based clustering has identified candidate segments.

FIG. 5 is a flowchart of an example process for automatically identifying handwritten signatures within digital images using OCR residues.

FIG. 6 is a diagram of an example computing system in which some described embodiments can be implemented.

FIG. 7 is an example cloud computing environment that can be used in conjunction with the technologies described herein.

### DETAILED DESCRIPTION

### Overview

The following description is directed to technologies for identifying handwritten signatures within digital images using OCR residues. For example, a digital image of a scanned document is received. The scanned document comprises typewritten content and handwritten content. Optical character recognition (OCR) is performed on the digital image to identify typewritten text within the digital image. Pixel areas containing the identified typewritten text are removed from the digital image (e.g., the pixel areas can be replaced with a solid background color). Density-based clustering is performed on the digital image to cluster remaining pixel data (the pixel data in the digital image after the identified typewritten text has been removed) within the digital image. The density-based clustering produces candidate segments (pixel areas that could contain handwritten content, such as handwritten signatures). The candidate segments are then processed using a trained image classifier. The trained image classifier determines whether a given candidate segment contains a handwritten signature. Results of the processing are then output. For example, an indication of which candidate segments contain digital signatures can be output. Furthermore, if at least one candidate segment contains a handwritten signature, then an indication that the scanned document is signed can be output.

Automated document processing techniques are able to efficiently scan and OCR paper documents. However, such automated document processing solutions have difficulty with recognizing handwritten content, such as handwritten signatures. Typically, handwritten content will not be recognized by the OCR process or will be recognized incorrectly (e.g., as a sequence of characters and not as a handwritten signature). Manual inspection can be used to determine if a scanned document contains a handwritten signature. However, manual inspection is an inefficient and error prone process.

The technologies described herein provide improvements over existing automated and manual document processing solutions. For example, OCR residues can be used as part of an automated process to identify handwritten content, including handwritten signatures, in digital images of scanned documents. The OCR residue is generated by removing the OCR identified content from the digital image (e.g., the pixel areas containing the identified typewritten text). The OCR residue is what contains the handwritten content that the OCR process was unable to recognize (e.g., unable to recognize with sufficient confidence). The OCR residue can then be processed using density-based clustering to cluster remaining pixel data and generate candidate segments. The candidate segments can be analyzed with a trained image classifier to determine if any contain a handwritten signature. In this way, an entirely computer automated process can be implemented for performing document processing to determine whether documents contain digital signatures (e.g., to determine whether a given document has been signed by a handwritten signature).

### Example Documents and Scanning

In the technologies described herein, documents are scanned and processed to automatically identify handwritten signatures. Handwritten signatures within scanned documents can be identified using a variety of techniques, separately or in combination. The techniques can comprise OCR processing, digital image manipulation (e.g., replacing and/or modifying pixel areas within a digital image), density-based clustering, digital image filtering (e.g., denoising), and/or image classification using machine learning.

As used herein, the term “document” refers to a paper document. A document contains two types of content. The first type of content is typewritten content, which refers to content that is printed on the document via a machine (e.g., a computer printer) and can comprise typewritten text (e.g., letters, numbers, symbols, characters, etc.) and/or other types of typewritten content (e.g., tables, charts, graphical content such as lines or logos, etc.). The second type of content is handwritten content. Handwritten content refers to content that is written by a person (e.g., a person using a pen or pencil). Examples of handwritten content include signatures (i.e., handwritten signatures), names (i.e., handwritten names), titles (i.e., handwritten titles), and dates (i.e., handwritten dates).

One example of a paper document is a contract. Typically, a contract contains both typewritten content (e.g., the text of the contract) and handwritten content (e.g., the signature and date of the person signing and dating the content). In general, any type of document that contains both typewritten content and handwritten content can be processed using the technologies described herein (e.g., invoices, purchase orders, letters, etc.).

In the technologies described herein, documents are scanned to create digital images of documents (also referred to as document images). For example, a computer scanner is used to scan a paper document and generate a digital image of the paper document. The digital image is in a digital image format (e.g., JPEG, GIF, TIFF, PDF, or another digital image format). For example, when scanning the document, the typewritten content and handwritten content of the document are converted to pixel data in the digital image format. A document can also be scanned using an image capture device not commonly referred to as a “scanner,” such as a digital camera. Therefore, the term “scanned document” refers to a digital image of a document, however the digital image is captured.

### Example Optical Character Recognition (OCR) of Digital Images of Scanned Documents

In the technologies described herein, optical character recognition can be performed on digital images of scanned documents. The OCR process identifies typewritten text within the digital image (e.g., letters, words, numbers, punctuation, and special characters). The OCR process can be performed using existing OCR programs. In some implementations, the OCR process is performed using an open-source OCR program, such as the Tesseract OCR engine (tesseract-ocr.github.io).

The result of the OCR process is an indication of the recognized typewritten text. In some implementations, the OCR results comprise the recognized text, positions of the recognized text within the digital image, and confidence information. For example, each recognized word or character can be associated with a position and/or confidence.

In some implementations, the OCR process uses a confidence threshold. In order for the OCR process to identify typewritten text within the digital image, the OCR process needs to be confident in its ability to recognize the text. For example, if a 90% confidence threshold is set, the OCR process will identify typewritten text (e.g., for a given pixel area of the digital image) if it is at least 90% confident in identifying the typewritten text in the given pixel area. Otherwise, if the OCR process is less than 90% confident, it will not recognize any typewritten text for the given pixel area, and the given pixel area will not be part of the pixel areas containing identified typewritten text (e.g., as output by the OCR process).

In some implementations, the OCR process outputs a table of results. In the table, each group of identified typewritten text (e.g. character, word, etc.) is a row, and the columns represent the coordinates (bounding box) and confidence scores for each row. The rows in the table that are at or above the confidence threshold can then be identified (e.g., if the confidence threshold is 90%, then the 90^{th} percentile of the confidence column can be computed and applied). These rows, and their corresponding identified typewritten text, are deemed to be identified with sufficient confidence and are then removed from the digital image in a subsequent operation. The remaining rows are not recognized, and their pixel data remains in the digital image.

### Example Processing of OCR Residue

In the technologies described herein, OCR is performed on digital images of scanned documents. The OCR process identifies typewritten text within the digital image. The identified typewritten text (e.g., identified with sufficient confidence) is removed from the digital image to generate an OCR residue, which is used for further processing.

The results of the OCR process are the typewritten text that the OCR process has identified (e.g., with sufficient confidence) within the digital image and the locations of the identified typewritten text. For example, each group of identified typewritten text (e.g., each individual character, word, sentence, and/or other grouping of identified typewritten text) is associated with its respective location within the digital image. The locations indicate a pixel area for each group of identified typewritten text, which is also referred to as a bounding box.

After the OCR process is complete and the identified typewritten text and locations are available, the identified typewritten text is removed from the digital image. In some implementations, removing the identified typewritten text is performed by removing the associated pixel areas containing the identified typewritten text from the digital image. The pixel areas can be removed by filling them in with a solid color, which in some implementations is the background color of the digital image. For example, if the digital image has a white background (e.g., because the paper document was on white paper), then the pixel areas can be filled in with white. This has the effect of “removing” the identified typewritten text as it has been replaced with solid white content.

After the identified typewritten text has been removed from the digital image, the remaining content within the digital image is referred to as the OCR residue. In other words, the OCR residue is the content within the digital image that remains after the identified typewritten text has been removed. The OCR residue comprises typewritten content that was not recognized by the OCR process (e.g., because it was not identified with sufficient confidence). For example, some of the typewritten text within the digital image may be of poor quality and therefore the OCR process could not identify it. The OCR residue also comprises other types of typewritten content, such as tables, graphics, logos, etc. The OCR residue also comprises noise pixels. For example, the digital image may contain noise content (e.g., artifacts from the scanning process). The OCR residue also comprises handwritten content (e.g., handwritten signatures, handwritten titles, handwritten dates, and/or other handwritten content) that was not recognized by the OCR process.

In some implementations, the OCR residue is processed using digital image processing techniques to remove noise content. For example, a denoising algorithm (also referred to as a noise reduction algorithm or filter) is applied to remove (or reduce) pixel noise content within the OCR residue. Removing or reducing noise content can improve the efficiency and/or accuracy of subsequent processing of the OCR residue. Various types of denoising algorithms can be applied to process the digital image. For example, linear smoothing and/or median filtering an be applied to reduce noise.

Density-based clustering is then performed using the OCR residue. Density-based clustering is performed to cluster remaining pixel data in the digital image. Density-based clustering will cluster the remaining pixel data into a number of clusters, which are translated into candidate segments (e.g., minimum bounding boxes of the clusters). In some implementations, density-based clustering is performed according to a minimum size parameter. The minimum size parameter defines the minimum size of a cluster, and can be useful to filter out small groups of remaining pixels (e.g., that are too small to be a typewritten signature). For example, the minimum size parameter can be defined as a percentage of the width and/or height of the digital image (e.g., the minimum size parameter could be 10% of the width of the digital image).

Because the clusters of pixel data produced by the density-based clustering can have arbitrary shapes, they are translated into candidate segments for output. A candidate segment for a given cluster is a rectangular area that encompasses the given cluster. In some implementations, the rectangular area is the minimum bounding box that encompasses the given cluster.

Once the candidate segments have been identified, they are processed using a trained image classifier. The trained image classifier has been trained to identify handwritten signatures in digital image content (e.g., using a supervised training process). The trained image classifier identifies whether a given candidate segment contains a handwritten signature.

The trained image classifier can be implemented using a variety of machine learning techniques. For example, the trained image classifier can be implemented by a neural network, a linear model, or another type of machine learning algorithm. In some implementations, the trained image classifier is implemented using pre-trained model for object detection that is further trained using additional training data to recognize handwritten signatures using training segments (e.g., using a continuous training process). In some implementations, the YOLOv3 pre-trained image classifier is used.

### Example Service Flow

In the technologies described herein, service flows can be provided to determine whether scanned documents are signed with handwritten signatures. The service flows can be performed by various types of computing devices. The service flows can also be provided as a service (e.g., a cloud service).

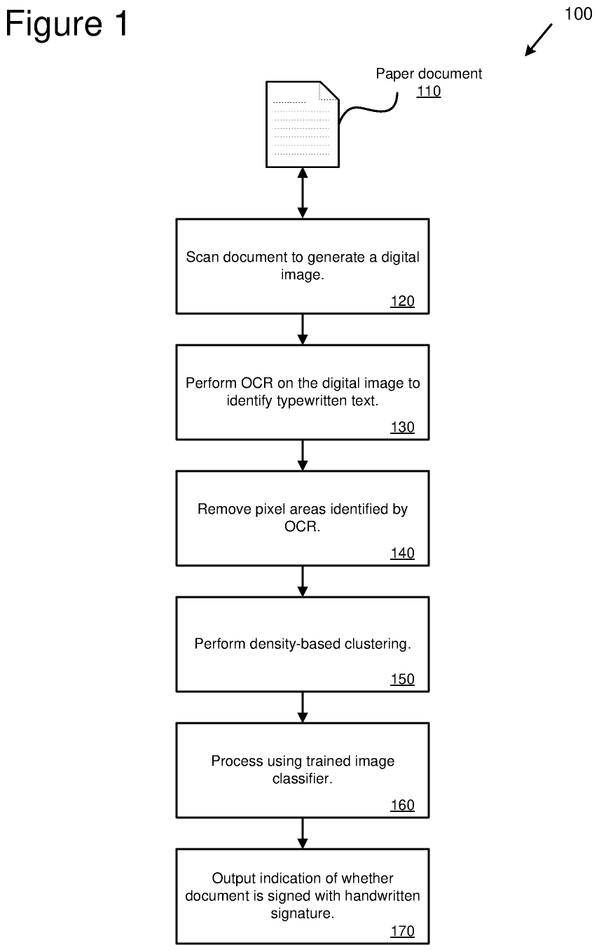

FIG. 1 depicts an example service flow 100 for determining whether a scanned document is signed with a handwritten signature. Depicted at 110 is a paper document. The paper document can be any type of document (e.g., a contract, invoice, purchase order, letter, or another type of paper document). The paper document comprises typewritten content and handwritten content.

At 120, the paper document 110 is scanned (e.g., using a scanning device, digital camera, or another type of device that generates a digital image of the paper document 110) to generate a digital image of the scanned document.

At 130, OCR is performed on the digital image to identify typewritten text within the digital image. For example, the typewritten text can be identified as words, numbers, symbols, sentences, or other arrangements of typewritten text. In some implementations, the OCR is performed using a confidence threshold. Using an example confidence threshold of 90%, if the OCR process is at least 90% confident in identifying typewritten text within a given pixel area, then the typewritten text within the given pixel area is successfully identified. However, if the OCR process is less than 90% confident, then the given pixel area is not identified. The 90% confidence threshold is used as an example, and a different confidence threshold may be used in actual implementations. For example, the confidence threshold can be determined based on empirical results, and different document characteristics (e.g., different types of documents, font type and size, scan quality, etc.) can influence the confidence threshold used.

At 140, The pixel areas that were identified by the OCR (e.g., identified with confidence at or above the confidence threshold) are removed from the digital image. In some implementations, the OCR process produces a rectangular pixel area for each identified element of typewritten text (e.g., letter, word, number, etc.). The pixel areas can be removed by filling them in with a solid color, such as the background color. For example, all of the pixel data within the pixel areas can be replaced with pixels all having the same value (e.g., all white pixels, all grey pixels, all black pixels, etc.).

At 150, density-based clustering is performed to cluster remaining pixel data in the digital image (pixel data that remains after the pixel areas containing the identified typewritten text have been removed). Density-based clustering will cluster the remaining pixel data into a number of clusters, which are translated into candidate segments.

In some implementations, the digital image is further processed using one or more image processing techniques. The image processing techniques can be applied before the density-based clustering is performed (e.g., as one or more pre-processing operations). In some implementations. For example, a denoising operation is performed on the digital image (e.g., as a noise reduction process), which can improve the accuracy and efficiency of the density-based clustering (e.g., so that the density-based clustering does not have to consider noise pixels). As another example, image processing is performed to remove lines in the digital image (e.g., horizontal and/or vertical lines). The lines could be part of a table outline or signature block lines. Removing lines, such as horizontal and/or vertical lines, can improve the efficiency of the density-based clustering.

At 160, the candidate segments are processed to determine whether they contain handwritten signatures. In some implementations, a trained image classifier is used to analyze each of the candidate segments and determine which, if any, contain a handwritten signature.

At 170, an indication of whether the document is signed with a handwritten signature is output. For example, the output can comprise indications of which of the candidate segments contain handwritten signatures (e.g., contain at least one handwritten signature). In some implementations, if at least one handwritten signature is found, then an indication that the scanned document is signed is output.

The example service flow 100 is performed by one or more computing devices running computer software. For example, a computing device (e.g., a desktop computer, laptop, tablet, smart phone, or another type of computing device) can receive a digital image of the paper document 100. The computing device can receive the digital image from a scanner (e.g., a document scanner) or from another source that generates a digital image of the paper document 110 (e.g., from a digital camera). The computing device can then perform the operations determine whether the paper document 110 contains a handwritten signature (e.g., performing the OCR, density-based clustering, denoising, and/or image classifier operations). In some implementations, a number of computing devices can be involved in the service flow. For example, a first computing device can receive the digital image (e.g., from a local or remote scanning device) and transmit the digital image to remote computing resources (e.g., cloud computing resources that operate a remote service) to perform the remaining operations.

### Example Digital Images of a Scanned Document

This section illustrates how a digital image of a scanned document is processed to determine whether it contains handwritten signatures. The processing includes performing OCR to identify typewritten text, removing pixel areas identified by the OCR, performing density-based clustering, and processing candidate segments using a trained image classifier. The processing can also include performing a denoising operation after the identified pixel areas are removed.

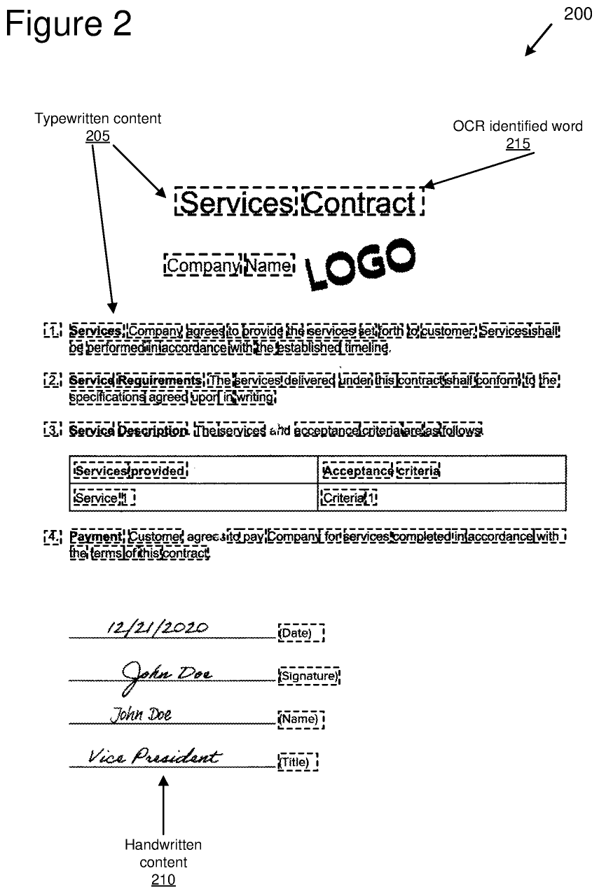

FIG. 2 depicts an example digital image 200 of a scanned document, including typewritten text that has been identified using OCR. Specifically, example digital image 200 depicts an example services contact document. The example services contract document contains typewritten content 205, including typewritten text (e.g., the title, company name, and paragraph text) and other typewritten content (e.g., the logo and the lines outlining the table). The example services contract document also contains handwritten content 210, including the handwritten date, the handwritten signature, the handwritten name, and the handwritten title.

The example digital image 200 has been processed using OCR. The OCR process has identified most of the typewritten text in the example digital image 200. The identified typewritten text is enclosed in dashed boxes. One example of identified typewritten text is the word “Contract” that enclosed by the dashed box depicted at 215. Some of the typewritten content has not been identified by the OCR process, either because it is of poor quality (e.g., it could not be identified with sufficient confidence) or because it is graphical content that the OCR process cannot identify (e.g., the logo, table lines, and lines under the signature block). The OCR process has also not identified the handwritten content 210.

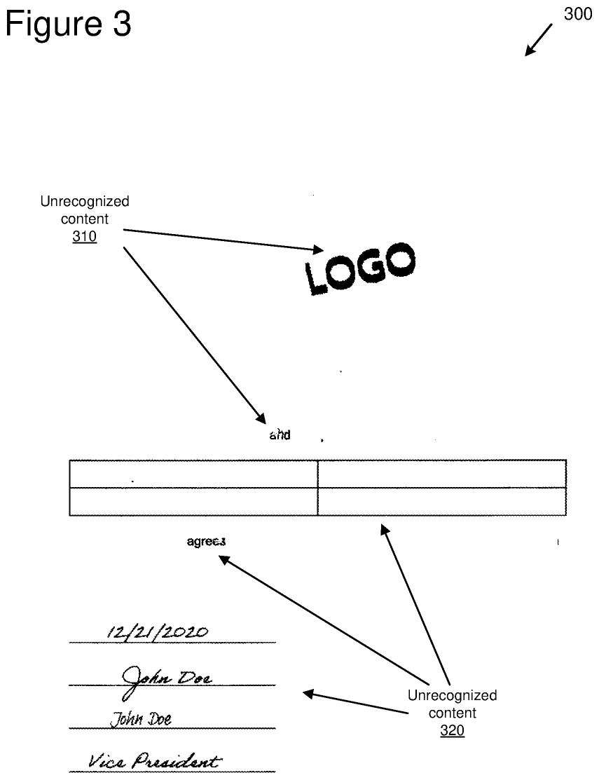

FIG. 3 depicts an example digital image 300 after the pixel areas containing identified typewritten text have been removed. The example digital image 300 depicts the same scanned document as depicted in the example digital image 200, but after additional operations have been performed. Specifically, the pixel areas enclosing the typewritten text that were identified by the OCR process (the dashed boxes depicted in FIG. 2) have been removed. In this example, the pixel areas have been replaced with solid white content, which is the background color of the digital image.

The pixel data that remains in the example digital image 300 after the identified typewritten text has been removed is the OCR residue. The OCR residue in this example is the content that could not be recognized by the OCR process. The unrecognized content depicted at 310 and 320 includes the graphical logo, the table lines, the handwritten content (handwritten date, signature, name, and title, and their respective horizontal underlines), and two words that are of poor quality and were not able to be recognized by the OCR process. The OCR residue also includes any additional pixel data, such as noise or artifact pixels.

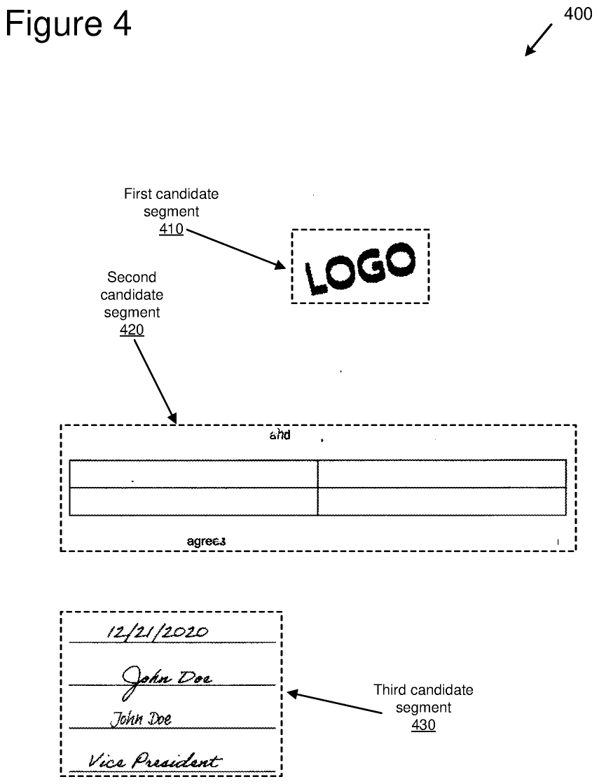

FIG. 4 depicts an example digital image 400 after the pixel areas containing identified typewritten text have been removed. The example digital image 400 depicts the same scanned document as depicted in the example digital image 300, but after additional operations have been performed. Specifically, density-based clustering has been performed on the OCR residue depicted in the example digital image 300. The density-based clustering has identified three clusters, which have been translated into three corresponding candidate segments. The first candidate segment 410 contains the graphical logo. The second candidate segment 420 contains two unrecognized pieces of text and the table lines. The third candidate segment 430 contains the handwritten content and signature block lines. Depending on the parameters used (e.g., the minimum size parameter and/or other parameters), density-based clustering could identify more clusters or fewer clusters. For example, the pixel data within the second candidate segment 420 could be identified as three separate candidate segments. Similarly, the pixel data within the third candidate segment 430 could be identified as four different candidate segments (e.g., one for the handwritten date, one for the handwritten signature, one for the handwritten name, and one for the handwritten title). The number of candidate segments can have some effect on efficiency of subsequent processing, but the subsequent processing (e.g., image classification) can still be applied to identify handwritten signatures regardless of the number of candidate segments.

The candidate segments 410, 420, and 430 can be input into a trained image classifier. The trained image classifier can identify which, if any, candidate blocks contain a handwritten signature. In this example, the trained image classifier would identify the third candidate block 430 as containing a handwritten signature (the handwritten signature of John Doe). Because the third candidate segment 430 contains a handwritten signature, an indication can be output that the scanned document has been signed.

### Methods for Automatically Identifying Handwritten Signatures within Digital Images

In the technologies described herein, methods can be provided for automatically identifying handwritten signatures within digital images using OCR residues. For example, OCR can be performed on a digital image of a scanned document to identify typewritten text. Pixel areas containing the typewritten text can be removed from the digital image. Density-based clustering can be performed on the remaining pixel data in the digital image (the OCR residue). A trained image classifier can be run on results of the density-based clustering to identify handwritten signatures (e.g., to identify whether candidate segments contain digital signatures).

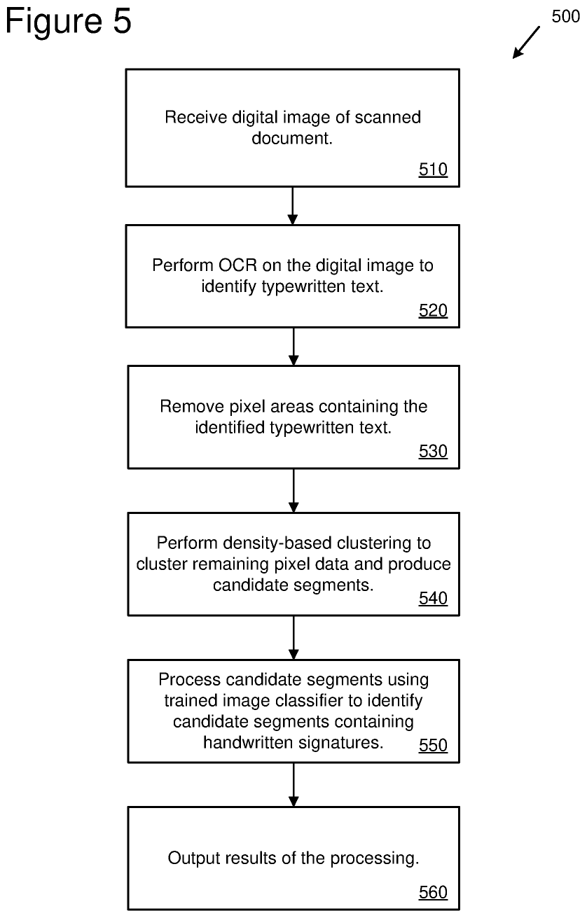

FIG. 5 is a flowchart depicting an example process 500 for automatically identifying handwritten signatures within digital images using OCR residues. At 510, a digital image of a scanned document is received. The scanned document comprises typewritten content and handwritten content.

At 520, OCR is performed on the digital image. The OCR identifies typewritten text within the digital image. In some implementations, the OCR identifies the typewritten text by applying a confidence threshold. If the OCR can recognize typewritten text within a given pixel area at or above the confidence threshold, then the OCR identifies the typewritten text. Otherwise, the OCR does not identify the given pixel area.

At 530, pixel areas containing the identified typewritten text are removed from the digital image. In some implementations, removing the pixel areas containing the typewritten text is done by filling in the pixel areas (e.g., rectangular pixel areas) with a solid background color (e.g., solid white).

At 540, density-based clustering is performed to cluster remaining pixel data and produce candidate segments. In some implementations, the density-based clustering is performed using a density-based spatial clustering of applications with noise (DBSCAN) algorithm. In other implementations, a different density-based clustering technique is used, such as generalized DBSCAN (GDBSCAN) or hierarchical DBSCAN (HDBSCAN).

At 550, the candidate segments are processed using a trained image classifier to identify candidate segments containing handwritten signatures. For example, the trained image classifier can identify which candidate segments contain at least one handwritten signature.

At 560, results of the processing are output. For example, the results can comprise indications of which candidate segments contain a handwritten signature. In some implementations, if at least one candidate segment contains a handwritten signature, then an indication that the scanned document is signed is output. The output can comprise saving the indication to a file, emailing the indication, displaying the indication on a computer user interface (e.g., a textual and/or graphical message), etc.

### Computing Systems

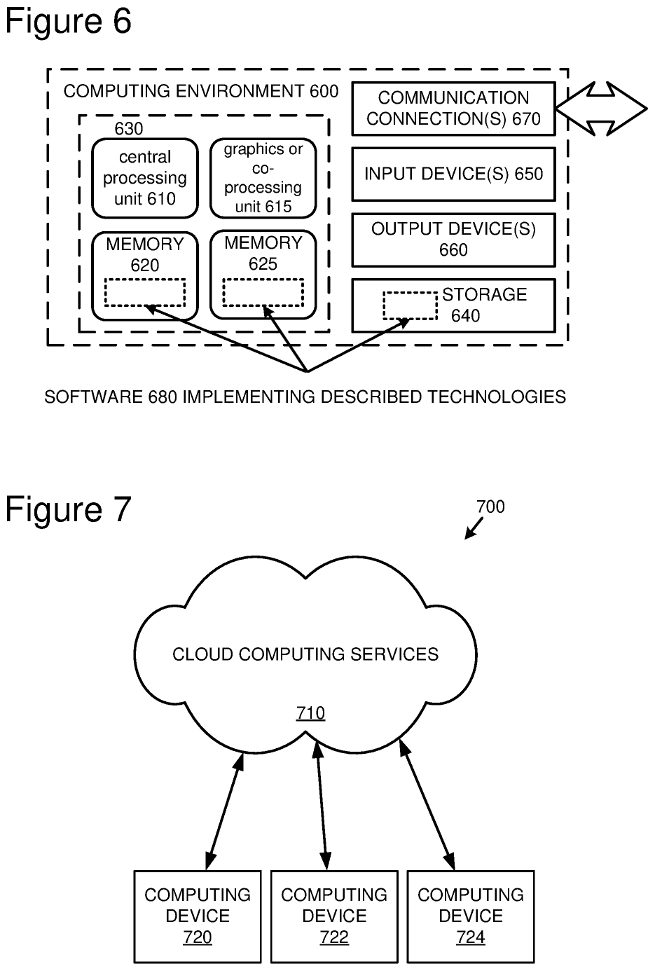

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud Computing Environment

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, database resources, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed by one or more computing devices, for automatically identifying handwritten signatures within digital images, the method comprising:
receiving a digital image of a scanned document, wherein the scanned document comprises typewritten content and handwritten content;
performing optical character recognition (OCR) on the digital image, wherein the OCR identifies typewritten text within the digital image;
removing pixel areas containing the identified typewritten text from the digital image;
performing density-based clustering on the digital image to cluster remaining pixel data within the digital image, wherein the density-based clustering produces candidate segments;
processing the candidate segments using a trained image classifier, wherein the trained image classifier identifies which of the candidate segments contain handwritten signatures; and
outputting results of the processing.

2. The method of claim 1, wherein performing the OCR on the digital image comprises:
applying a confidence threshold;
wherein the typewritten text is identified, by the OCR, with confidence at or above the confidence threshold from pixel data within the digital image.

3. The method of claim 1, wherein removing the pixel areas containing the identified typewritten text from the digital image comprises:
filling in the pixel areas with a solid background color.

4. The method of claim 1, wherein the remaining pixel data is OCR residue remaining in the digital image after the pixel areas containing the identified typewritten text have been removed.

5. The method of claim 1, wherein the density-based clustering is performed using a density-based spatial clustering of applications with noise (DBSCAN) algorithm.

6. The method of claim 1, wherein the candidate segments are defined by respective minimum bounding boxes of clustered pixel data identified by the density-based clustering.

7. The method of claim 1, further comprising:
after removing the pixel areas containing the identified typewritten text from the digital image, applying digital image denoising to the digital image, wherein the density-based clustering is performed using the denoised digital image.

8. The method of claim 1, further comprising:
when at least one candidate segment is determined to contain a handwritten signature, outputting an indication that the scanned document has been signed.

9. The method of claim 1, wherein the trained image classifier is trained to distinguish between candidate segments that contain handwritten signatures and candidate segments that contain other types of handwritten content or typewritten content.

10. The method of claim 1, wherein the trained image classifier is implemented by a neural network.

11. One or more computing devices comprising:
processors; and
memory;
the one or more computing devices configured, via computer-executable instructions, to automatically identify handwritten signatures within digital images, the operations comprising:
receiving a digital image of a scanned document, wherein the scanned document comprises typewritten content and handwritten content;
performing optical character recognition (OCR) on the digital image, wherein the OCR identifies typewritten text within the digital image;
removing pixel areas containing the identified typewritten text from the digital image;
after removing the pixel areas containing the identified typewritten text from the digital image, applying digital image denoising to the digital image;
performing density-based clustering on the digital image to cluster remaining pixel data within the digital image, wherein the density-based clustering produces candidate segments;
processing the candidate segments using a trained image classifier, wherein the trained image classifier identifies which of the candidate segments contain handwritten signatures; and
outputting results of the processing.

12. The one or more computing devices of claim 11, wherein removing the pixel areas containing the identified typewritten text from the digital image comprises:
filling in the pixel areas with a solid background color.

13. The one or more computing devices of claim 11, wherein the remaining pixel data is OCR residue remaining in the digital image after the pixel areas containing the identified typewritten text have been removed.

14. The one or more computing devices of claim 11, wherein the candidate segments are defined by respective minimum bounding boxes of clustered pixel data identified by the density-based clustering.

15. The one or more computing devices of claim 11, the operations further comprising:
when at least one candidate segment is determined to contain a handwritten signature, outputting an indication that the scanned document has been signed.

16. One or more computer-readable storage media storing computer-executable instructions for execution on one or more computing devices to perform operations to automatically identify handwritten signatures within digital images, the operations comprising:
receiving a digital image of a scanned document, wherein the scanned document comprises typewritten content and handwritten content;
performing optical character recognition (OCR) on the digital image, wherein the OCR identifies typewritten text within the digital image;
removing pixel areas containing the identified typewritten text from the digital image to generate an OCR residue;
performing density-based clustering on the OCR residue to cluster remaining pixel data within the OCR residue, wherein the density-based clustering produces candidate segments;
processing the candidate segments using a trained image classifier, wherein the trained image classifier identifies which of the candidate segments contain handwritten signatures; and
based on results of the processing, outputting an indication of whether the scanned document is signed.

17. The one or more computer-readable storage media of claim 16, wherein removing the pixel areas containing the identified typewritten text from the digital image comprises:
filling in the pixel areas with a solid background color.

18. The one or more computer-readable storage media of claim 16, wherein the candidate segments are defined by respective minimum bounding boxes of clustered pixel data identified by the density-based clustering.

19. The one or more computer-readable storage media of claim 16, the operations further comprising:
when at least one candidate segment is determined to contain a handwritten signature, outputting an indication that the scanned document has been signed.

20. The one or more computer-readable storage media of claim 16, wherein the trained image classifier is trained to distinguish between candidate segments that contain handwritten signatures and candidate segments that contain other types of handwritten content or typewritten content.
